(19) United States
(12) Patent Application Publication
(10) Pub. No.: US 2011/0296757 A1
(43) Pub. Date: Dec. 8, 2011

(54) Portable Hydroponic Terrace Cart

(76) Inventor: Kevin Robert McGrath, Manitou Beach, MI (US)

(21) Appl. No.: 12/792,085

(22) Filed: Jun. 2, 2010

(51) Int. Cl. A01G 31/02; B01D 35/00

(52) U.S. Cl. 47/62 R; 137/544

(57) ABSTRACT

A hydroponics apparatus for growing plants. The apparatus includes a frame attached to a base; the frame includes a frame member having an angled portion at an angle with respect to the base. A plurality of substantially parallel tubes are attached to the angled portion of the frame member, so that the tubes are terraced with respect to each other. Connectors connect the tubes at the ends thereof, thereby forming a single serpentine path for fluid flow. A reservoir is connected to an end of the lowermost tube, for collecting fluid flowing from the tubes. A pump is provided for pumping the fluid into the tubes. In various embodiments, the angled portion of the frame member is at an angle of approximately 45° elevation with respect to the base, and the tubes have netpots for holding the plants.

### FIELD OF THE DISCLOSURE

This disclosure relates to hydroponic gardening, and more particularly to a portable apparatus for implementing a variety of hydroponic methods.

### BACKGROUND OF THE DISCLOSURE

Portable hydroponics gardening systems have been described in the patent literature. For example, U.S. Pat. No. 5,067,275 to Constance discloses a hydroponic garden utilizing conventional flower pots for growing chambers and a plastic PVC pipe supporting the flower pots through openings in the upper wall of the pipe, so that a nutrient solution circulating through the plastic pipe feeds the plants growing in the flower pots. A timer controlled pump circulates the nutrient solution from a reservoir through the conduit and back to the reservoir according to a predetermined program.

U.S. Patent Application Publication No. 2001/0047617 of Blossom shows a portable hydroponic garden apparatus. This apparatus generally includes a frame and a reservoir for holding nutrient solution. One or more receptacles are disposed across the reservoir above the nutrient solution and are designed to hold plants. A solution distribution assembly is provided for delivering the nutrient solution from the reservoir to the one or more receptacles so that the nutrient solution is discharged over a surface of the one or more receptacles and the nutrient solution is fed to the plants. The receptacle has drainage means so that the nutrient solution drains back into the reservoir. The nutrient solution is constantly circulated throughout the apparatus and the nutrient is aerated in the process. Aeration of the nutrient solution leads to better plant growth because the level of air within the nutrient solution is optimized.

U.S. Pat. No. 4,048,753 to Roberts, Jr., et. al describes a hydroponic garden structure. A horizontal tray is provided for growing plants; a liquid nutrient reservoir for receiving a predetermined amount of liquid nutrient therein is supported, in counterbalanced fashion, for vertical shifting relative to the tray between an upper position elevated relative to the tray and a lowered position depressed relative to the tray. The support structure supporting the nutrient reservoir in counter-balanced fashion is slightly over balanced, to cause the support means to shift the nutrient reservoir by gravity toward the upper position thereof. A flexible drain tube communicates the lower portions of the interiors of the tray and reservoir for draining nutrient from the reservoir into the tray, upon movement of the reservoir to the upper position thereof, and return drainage of nutrient from the tray into the reservoir upon subsequent movement of the reservoir to the depressed position thereof. A structure is provided to releasably retain the reservoir in the depressed position. Another disclosed structure includes a counterbalance water tank for the reservoir, operatively connected to a suitable water supply for slow filling of the water tank to an over balanced condition and provided with a drain for slow drainage of water from the tank to an under balanced condition; the reservoir may thus return, by gravity, to the depressed position thereof.

U.S. Pat. No. 6,622,425 to Shepherd is directed to a portable, wheeled greenhouse including a chassis that can be wheeled and having upper and lower end portions. The upper end portion includes a tub-like reservoir with sidewalls and bottom wall. One or more racks are supported upon the combination of wheeled chassis and tub and above the bottom of the tub, so that each rack is sized and shaped to support and suspend a plurality of potted plants above the bottom, yet close enough to the bottom of the tub so that any water that is optionally contained within the tub contacts the supported pot and waters them via wick action. A translucent or transparent canopy fits about the combination of tub and chassis; the canopy can include a support frame with a cover.

U.S. Pat. No. 5,448,853 to Harman shows a portable plant growing cart that can accommodate one or more plant trays thereon. This cart is constructed of a plurality of rigid frames which preferably are pivotally connected together so as to aid in the storage of the cart when not in use. A movable light source is supported from these separate frames above the trays at any desired elevation. In addition, a fabric-like reflective shroud is supported over both the light source and the cart so as to reflect light back towards the plant trays when desired.

There remains a need for a portable hydroponic apparatus (hydroponic cart) that is both compact and adaptable to a variety of hydroponic gardening methods.

### SUMMARY OF THE DISCLOSURE

The present disclosure provides a hydroponics apparatus for growing plants. The apparatus includes a frame attached to a base; the frame includes a frame member having an angled portion at an angle with respect to the base. A plurality of substantially parallel tubes are attached to the angled portion of the frame member, so that the tubes are terraced with respect to each other. Connectors connect the tubes at the ends thereof, thereby forming a single serpentine path for fluid flow. A reservoir is connected to an end of the lowermost tube, for collecting fluid flowing from the tubes. A pump is provided for pumping the fluid into the tubes. In various embodiments, the angled portion of the frame member is at an angle of approximately 45° elevation with respect to the base, and the tubes have netpots for holding the plants.

Each of the tubes has a downstream end in accordance with the path for fluid flow; in embodiments implementing an ebb-and-flow hydroponic feeding application, a dam is disposed inside each tube at the downstream end thereof. The dam has a height sufficient to establish a fluid level in the tube so as to flood at least a portion of the netpots installed in the tube, thereby promoting root growth of the plant in the netpot.

In embodiments implementing an aquaponics feeding application, live fish are disposed in the reservoir, in order to supply naturally occurring nitrogen to the plants. This effectively creates an ecosystem including the plants and the fish; no chemically added nutrients will be necessary.

In embodiments implementing an aeroponics feeding application, a high pressure/low volume pump is provided which pumps the nutrient solution into supply lines running along the tubes; micron sized spray nozzles are connected to the lines at locations corresponding to the netpots containing the plants, and introduce the nutrient solution into the tubes at those locations. No dams inside the tubes are used, and the solution flows back to the reservoir completely.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a left end view of a hydroponic terrace cart according to an embodiment of the disclosure.

FIG. 2 is a front view of the hydroponic terrace cart shown in FIG. 1.

FIG. 3 is a detail view of the interior of a tube in the hydroponic terrace cart of FIGS. 1 and 2, showing how an ebb-and-flow method may be implemented using an embodiment of the disclosure.

FIG. 4 shows the hydroponic terrace cart of FIG. 1, modified to implement an aquaponics method, in accordance with another embodiment of the disclosure.

FIG. 5 is a front view of a hydroponic terrace cart implementing an aeroponics method, in accordance with a further embodiment of the disclosure.

### DETAILED DESCRIPTION

A hydroponics cart constructed according to the disclosure is a portable and complete terrace style hydroponics system. Embodiments of the disclosure include various hydroponics components including net pots, a nutrient reservoir, pumps, filters, an accumulator, plumbing, etc., with a tubular frame in a conveniently mobile aluminum cart device. In accordance with embodiments of the disclosure, the hydroponics cart is effective for employment of the major hydroponic methods including ebb-and-flow, aquaponic, aeroponic and the like.

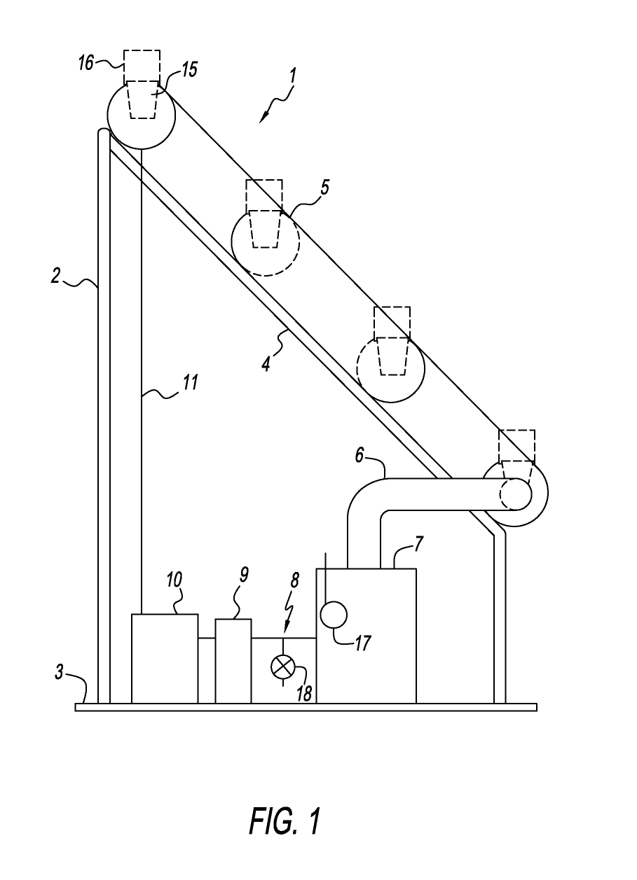

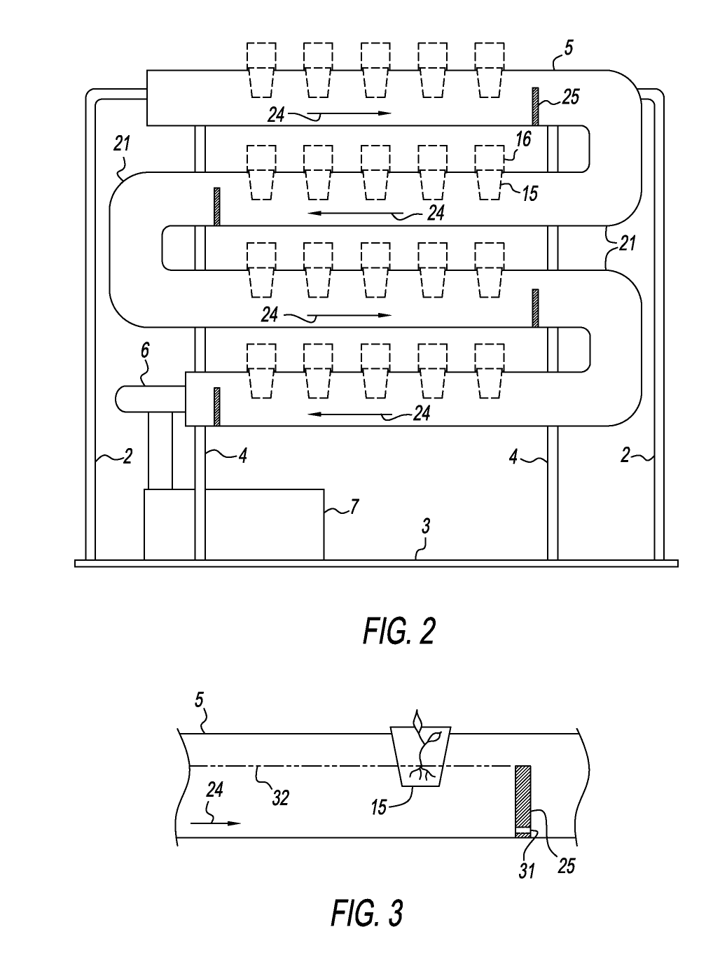

FIGS. 1 and 2 are left end and front views, respectively, of a portable hydroponics cart according to an embodiment of the disclosure. Hydroponics cart 1 has a tubular aluminum frame including two uprights 2 at the rear of base 3; the upper ends of the uprights are connected by a horizontal tube 12. The frame also includes tubular members 4 extending downwards from the horizontal tube 12 and secured to the base near the front thereof. In this embodiment, the upper portion of each tubular member 4 extends downward at a 45° angle with respect to the uprights and the base, thereby making a 45° angle of elevation with respect to the base.

Connected tubes 5 are secured to the angled tubular members 4, thereby forming a terraced arrangement of hydroponic tubes (best shown in FIG. 1). In the embodiment shown, four substantially parallel tubes are connected at the ends thereof by U-shaped connectors 21, thereby forming a serpentine path for the flow of water and nutrients. In this embodiment, tubes 5 and connectors 21 are made of PVC pipe. Water and nutrients flow naturally through all four tubes in the direction of arrow 24 (see FIG. 2). At the end 13 of the bottom tube, a drainpipe 6 conducts the flow into a reservoir 7. In this embodiment, reservoir 7 may be made of aluminum, integral with the base of the cart. A pipe 14, connecting to a manifold 8, leads away from reservoir 7 to a filter 9 and thence to a pump 10. Pump 10 may advantageously be a magnetic drive pump, where the pump impeller has permanent magnets attached thereto which are magnetically coupled to magnets on a rotor driven by an electric motor. Since there is no mechanical connection between the impeller and the motor shaft, leakage of the fluid being pumped is avoided.

Each of the tubes 5 has netpots 15 installed therein; the netpots contain the growing plants. Each netpot may be provided with a cage 16, mounted over the netpot, to support and contain plant growth.

As shown in FIG. 1, manifold 8 has a drain valve 18 attached thereto. The reservoir 7 may also include an attachment (with an opening port 19 and a container 17 below the fluid level in the reservoir, shown schematically in FIG. 1) to allow the addition of media to colonize and sustain beneficial bacteria submersed in the nutrient solution.

In accordance with various embodiments of the disclosure, the hydroponics cart 1 may be adapted for three different hydroponic feeding applications, as detailed below.

### Ebb and Flow

In this embodiment, magnetic driven pump 10 supplies a fluid nutrient solution to the top hydroponic tube via supply line 11. Inside each tube 5, near the downstream end thereof, a dam 25 causes the nutrient solution to collect behind it. Flow of the nutrient solution in direction 24 causes the fluid to rise to level 32 behind the dam. Dam 25 is constructed to allow the water to rise to a level flooding the netpots 15 containing the plant (or the plant cutting or seedling) sufficiently to stimulate root growth. FIG. 3 shows a portion of tube 5 with dam 25. Dam 25 also has two holes 31 (one shown in FIG. 3) in the bottom portion thereof, to allow complete drainage at the end of each timed pump cycle. In this embodiment, each hole 31 is approximately ¼ inch in diameter. As the pump 10 continues to run, the fluid spills over the top of dam 25 and into the tube below. At the end of the lowest tube, the fluid overflows the dam and creates a waterfall at the entry point of the reservoir, thereby aerating the solution. When the pump 10 stops, the water will gravity feed via the holes 31 in each dam in thus return to the reservoir 7.

### Aquaponics

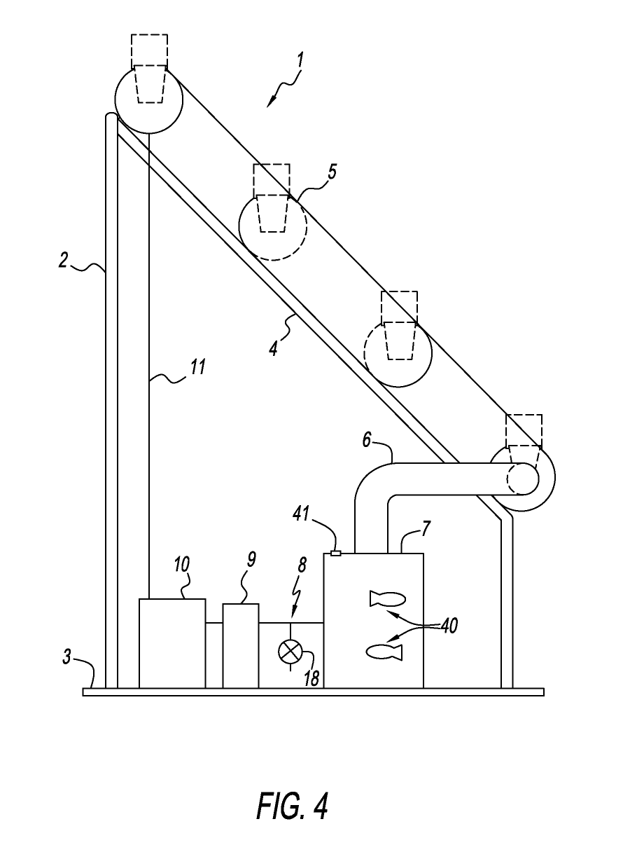

In an embodiment implementing the aquaponics method (see FIG. 4), the hydroponics apparatus is similar to that used for the ebb and flow method but incorporates live fish 40 in the reservoir 7, in order to supply naturally occurring nitrogen to the plants. This will in effect create an ecosystem including the plants and the fish; no chemically added nutrients will be necessary. Fish food is added to the reservoir using opening port 41.

### Aeroponics

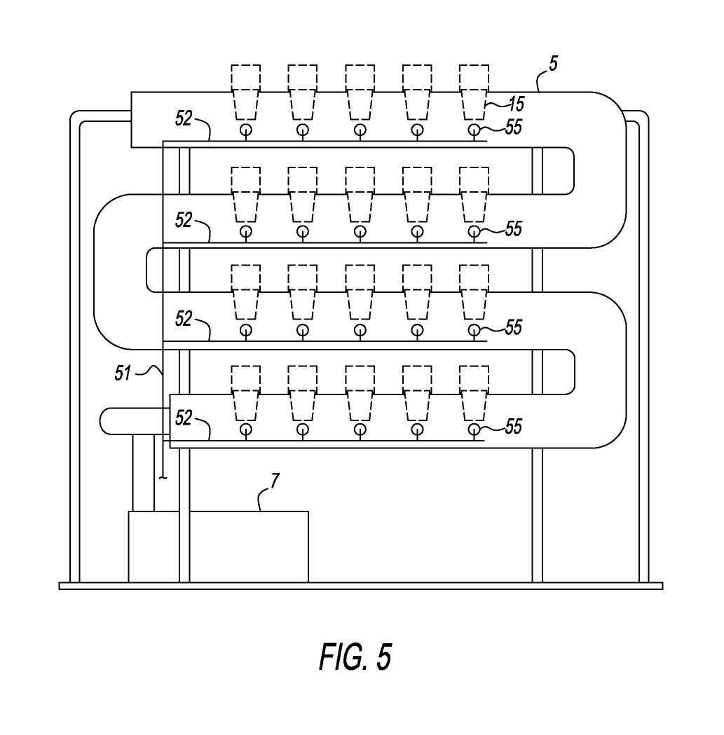

FIG. 5 shows an embodiment of the disclosure implementing the aeroponics method. In this embodiment, a high pressure/low volume pump (not shown in FIG. 5) pumps the nutrient solution into supply line 51 and thence into lines 52, branching from line 51 and running along tubes 5. Micron sized spray nozzles 55 are connected to lines 52 at locations corresponding to the netpots 15 containing the plants, and introduce the nutrient solution into tubes 5. No dams inside the tubes are used, and the solution flows back to the reservoir completely.

In other embodiments, the hydroponics cart includes one or more accessories; for example, an arm (mounted to the frame and matching the 45° angle of the hydroponic tube terrace) for attaching various lighting fixtures thereto. Filter 9 may be a spin down micron filter to assure a supply of clean solution to the pump. Another embodiment of the hydroponics cart includes a colloidal silver generator system for destruction of foreign pathogens and contaminates.

It will be appreciated that the 45° terrace arrangement of the hydroponic tubes permits natural water flow and concurrent multilevel nutrient delivery. In further embodiments, two or more frames may be positioned to achieve a pyramid-like configuration.

The terrace need not be restricted to a single plane. In an additional embodiment, the frame may be arranged in a semicircle while maintaining a 45° terrace angle, with a light source at the center of the semicircle. The plants would then be disposed in a half stadium configuration, with each plant located on a radius extending from the light.

A hydroponics cart according to the disclosure will permit people to grow any plant desired, in an all inclusive package utilizing the most efficient and desirable hydroponic presently available. An additional benefit of a hydroponics cart embodying the disclosure is that it is easily accessible, and usable, by handicapped persons.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. A hydroponics apparatus for growing plants, comprising:
a frame attached to a base, the frame including a frame member having an angled portion at an angle with respect to the base;
a plurality of substantially parallel tubes attached to said frame member, so that the tubes are terraced with respect to each other;
connectors connecting the tubes at the ends thereof, thereby forming a single serpentine path for fluid flow;
a reservoir connected to an end of the lowermost tube, for collecting fluid flowing from the tubes;
a pump for pumping the fluid into the tubes.

2. A hydroponics apparatus according to claim 1, wherein said angled portion of the frame member is at an angle of approximately 45° elevation with respect to the base.

3. A hydroponics apparatus according to claim 1, wherein the frame and the reservoir are aluminum, and the reservoir is formed integral with the base.

4. A hydroponics apparatus according to claim 1, further comprising
a pipe for conducting fluid away from the reservoir;
a manifold connected to said pipe; and
a drain valve connected to said manifold.

5. A hydroponics apparatus according to claim 4, further comprising a filter connected to said pipe, for filtering the fluid prior to the fluid entering the pump.

6. A hydroponics apparatus according to claim 5, wherein the filter is a spin down micron filter.

7. A hydroponics apparatus according to claim 1, further comprising netpots installed in said tubes for containing plants.

8. A hydroponics apparatus according to claim 7, further comprising cages mounted over the respective netpots.

9. A hydroponics apparatus according to claim 1, further comprising a supply line connecting the pump with an end of the uppermost tube, so that the fluid flows the length of the serpentine path.

10. A hydroponics apparatus according to claim 1, wherein each of said tubes has a downstream end in accordance with the path for fluid flow, and further comprising a dam disposed inside each tube at the downstream end thereof.

11. A hydroponics apparatus according to claim 10, wherein the dam has a height sufficient to establish a fluid level in the tube so as to flood at least a portion of the netpots installed in the tube, thereby promoting root growth of the plant in the netpot.

12. A hydroponics apparatus according to claim 10, wherein the dam has a hole in a lower portion thereof.

13. A hydroponics apparatus according to claim 1, wherein the reservoir further comprises an attachment configured to allow the addition of media to colonize and sustain beneficial bacteria submersed in the nutrient solution.

14. A hydroponics apparatus according to claim 9, wherein the reservoir has live fish disposed therein to supply naturally occurring nitrogen to the plants.

15. A hydroponics apparatus according to claim 1, further comprising
a supply line connected to the pump;
branching supply lines connected to the supply line, each branching supply line substantially parallel to one of the tubes; and
nozzles connected to the branching supply lines and to the respective tubes, for introducing fluid at a plurality of locations along the tubes.

16. A hydroponics apparatus according to claim 15, wherein the nozzles are located so as to introduce fluid at locations corresponding to the netpots.

17. A hydroponics apparatus according to claim 1, wherein said fluid comprises a solution of plant nutrient in water.

18. A hydroponics apparatus according to claim 1, further comprising an arm, mounted to the frame, for attaching lighting fixtures thereto, the arm elevated at approximately said angle with respect to the base so as to provide light to each of the plants in the tubes terraced with respect to each other.

19. A hydroponics apparatus according to claim 1, further comprising a colloidal silver generator system.

20. A hydroponics apparatus according to claim 1, wherein the frame and the tubes are arranged in a semicircle, the plants thereby being disposed in a half stadium configuration.
